(19) United States
(12) Patent Application Publication
(10) Pub. No.: US 2024/0137774 A1
(43) Pub. Date: Apr. 25, 2024

(54) SYSTEMS AND METHODS FOR MANAGING A MULTI-OPERATOR RADIO ACCESS NETWORK WITH A SINGLE RADIO UNIT

(71) Applicant: Verizon Patent and Licensing Inc., Basking Ridge, NJ (US)

(72) Inventors: David Albert ROSSETTI, Randolph, NJ (US); Madhusudan Mandyam BHEEMARAYAN, Hillsborough, NJ (US); Sylvestre DEMONGET, Millburn, NJ (US); Anand J. SHAH, Parsippany, NJ (US)

(73) Assignee: Verizon Patent and Licensing Inc., Basking Ridge, NJ (US)

(21) Appl. No.: 18/048,211

(22) Filed: Oct. 19, 2022

(51) Int. Cl. H04W 16/14

(52) U.S. Cl. CPC H04W 16/14

(57) ABSTRACT

A network device may receive a first frequency, time, and phase synchronization from a first occupied bandwidth (OBW) portion provided by the network device, and may utilize the first frequency, time, and phase synchronization when providing first services to the first OBW portion. The network device may receive a second frequency, time, and phase synchronization from a second OBW portion provided by the network device, and may utilize the second frequency, time, and phase synchronization when providing second services to the first OBW portion.

### BACKGROUND

A private network may include a mobile network that is a public mobile network, but can operate privately so that an owner can provide priority access or licensing for a wireless spectrum of a private network, a neural host network, and/or an in-building network.

### BRIEF DESCRIPTION OF THE DRAWINGS

FIGS. 1A-1F are diagrams of an example associated with managing a multi-operator radio access network (MORAN) with a single radio unit (RU).

FIG. 2 is a diagram of an example environment in which systems and/or methods described herein may be implemented.

FIG. 3 is a diagram of example components of one or more devices of FIG. 2.

FIG. 4 is a flowchart of an example process for managing a MORAN with a single RU.

### DETAILED DESCRIPTION OF EXAMPLE EMBODIMENTS

The following detailed description of example implementations refers to the accompanying drawings. The same reference numbers in different drawings may identify the same or similar elements.

It is advantageous for private networks to share radio resources (e.g. transceivers, antenna, spectrum, and/or the like) with public networks. A venue with a private network may include network devices owned by a network operator (e.g., arena) and network devices owned by one or more network providers (e.g., cellular service providers). Each network operator may control the network devices owned by the network operator and may utilize network devices provided by different vendors. The network provider may provide resources for the private network and for a public network owned by the network provider. Two examples of radio access network (RAN) configurations supporting such a private and public or a multiple public networks are a multi-operator radio access network (MORAN) and a multi-operator core network (MOCN), where the network devices of multiple network operators or providers may be shared. For MORAN or MOCN, a radio unit (RU), a centralized unit (CU), and a distributed unit (DU) are shared between all operators.

Thus, current mechanisms for managing a MORAN consume computing resources (e.g., processing resources, memory resources, communication resources, and/or the like), networking resources, and/or other resources associated with inefficiently providing services to the private networks of the MORAN, failing to provide sufficient interfaces for the quantity of private networks, failing to provide time aligned TDD signals for the private networks, failing to provide the same duty cycles for the private networks, failing to enable each operator to use preferred CU and DU solutions in their local networks, and/or the like.

Some implementations described herein provide a network device (e.g., an RU) that provides a central point of control for a MORAN. For example, the RU may receive a first frequency, time, and phase synchronization from a first occupied bandwidth (OBW) portion provided by the network device, and may utilize the first frequency, time, and phase synchronization when providing first services to the first OBW portion. The RU may receive a second frequency, time, and phase synchronization from a second OBW portion provided by the network device, and may utilize the second frequency, time, and phase synchronization when providing second services to the first OBW portion.

Implementations described herein may provide a MORAN-like configuration where a CU and a DU may be dedicated and not shared. For example, an RU of a network provider may be directly shared between different network operators, where each network operator provides their own CU and DU, possibly offsite at different locations and from different vendors. Each network operator may receive a portion of an OBW provided by the RU spread across one or more bands. To implement a MORAN with a single RU, the RU may include sufficient interfaces (e.g., enhanced common public radio interface (eCPRI) ports) based on a quantity of private networks supported by the RU. Furthermore, for time division duplex (TDD) operation, the RU may ensure that TDD signals from the private networks are time aligned and have the same duty cycles.

In this way, the RU manages a MORAN. For example, the RU may receive frequency, time, and phase synchronizations from the private networks and may ensure that a proper frequency, time, and phase synchronization is provided for each of the private networks. The RU may ensure that operational parameters are aligned between the different private networks, and may enforce the operational parameters on all of the private networks. Thus, the RU may conserve computing resources, networking resources, and/or other resources that would otherwise have been consumed in inefficiently providing services to the private networks of the MORAN, failing to provide sufficient interfaces for the quantity of private networks, failing to provide time aligned TDD signals for the private networks, failing to provide the same duty cycles for the private networks, and/or the like.

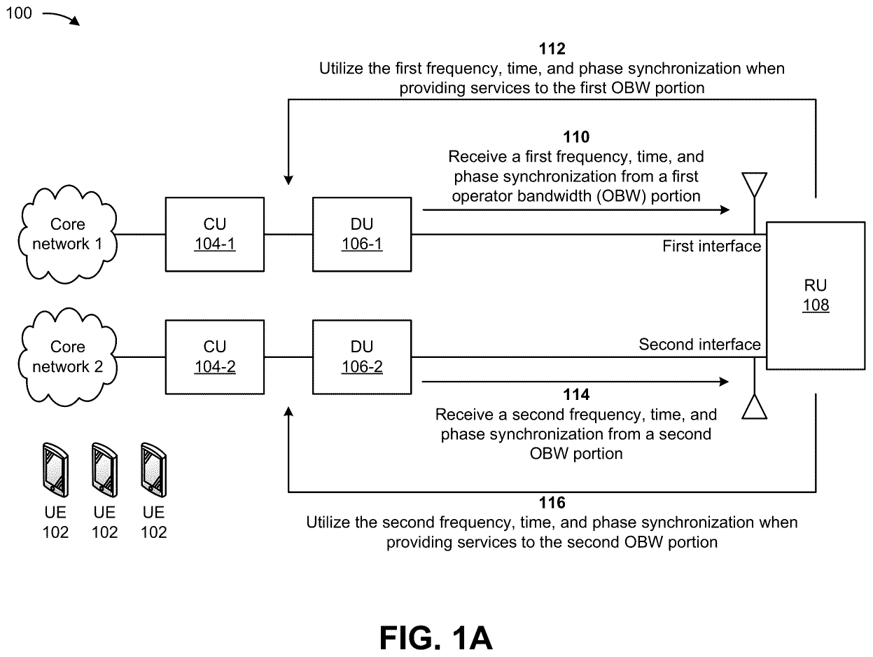

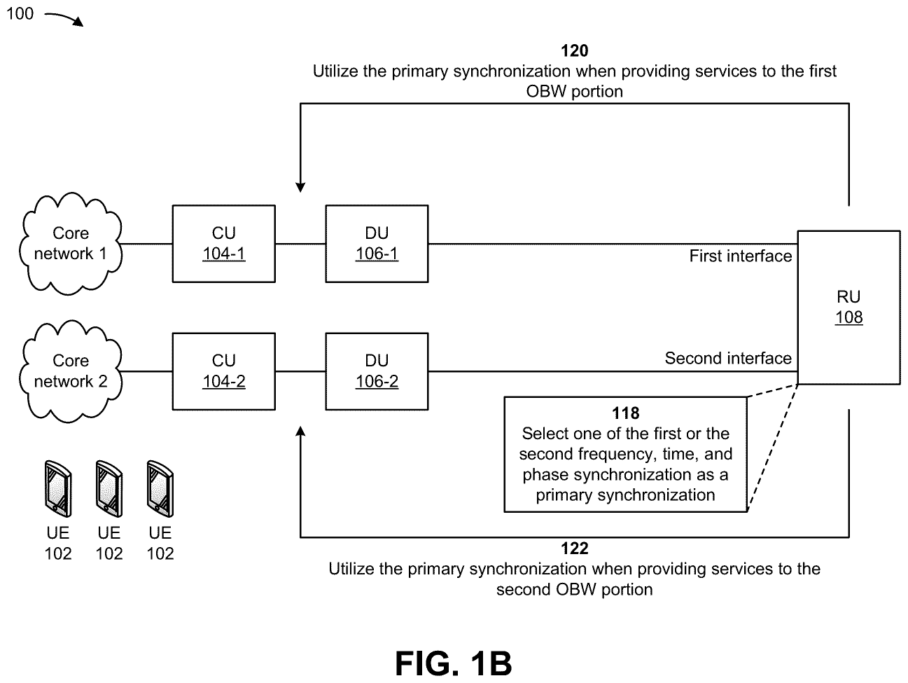

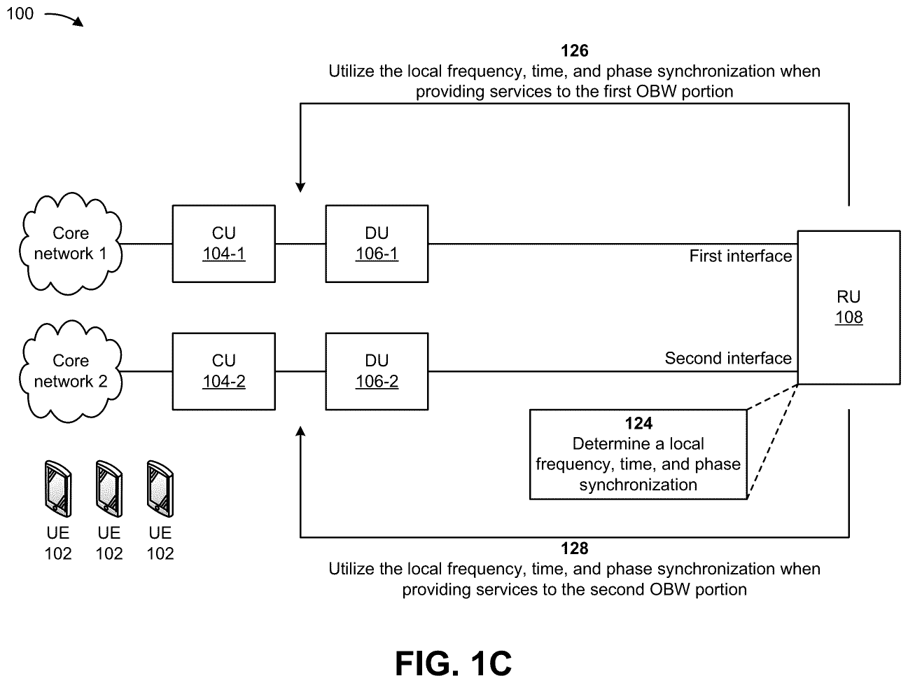

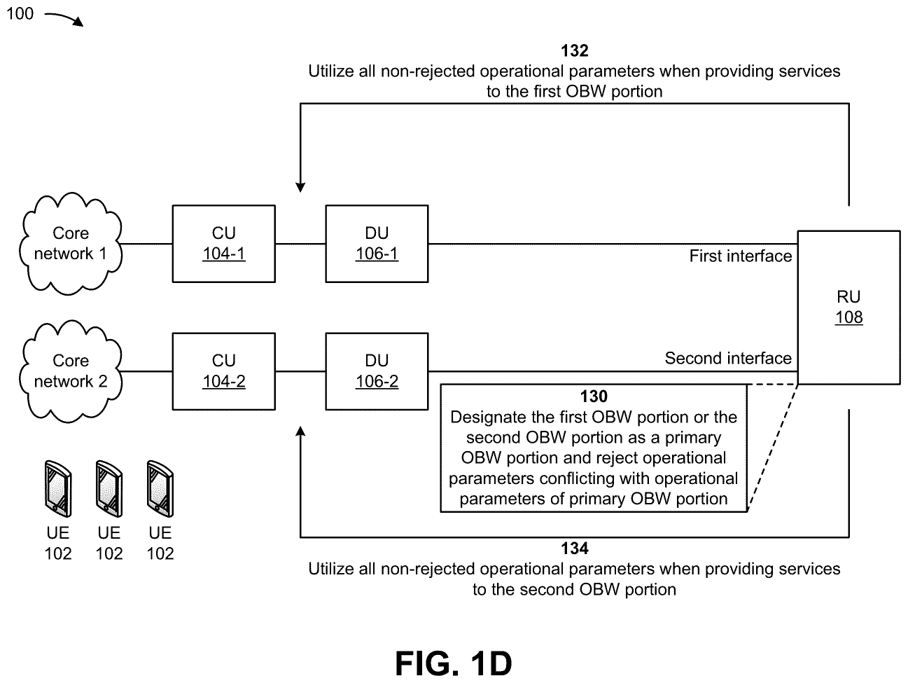

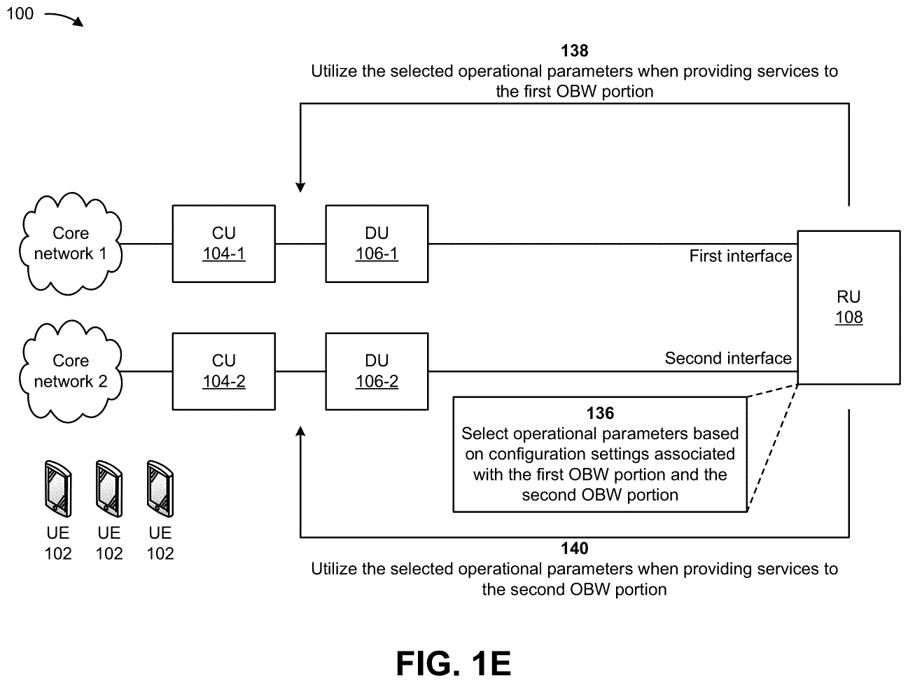

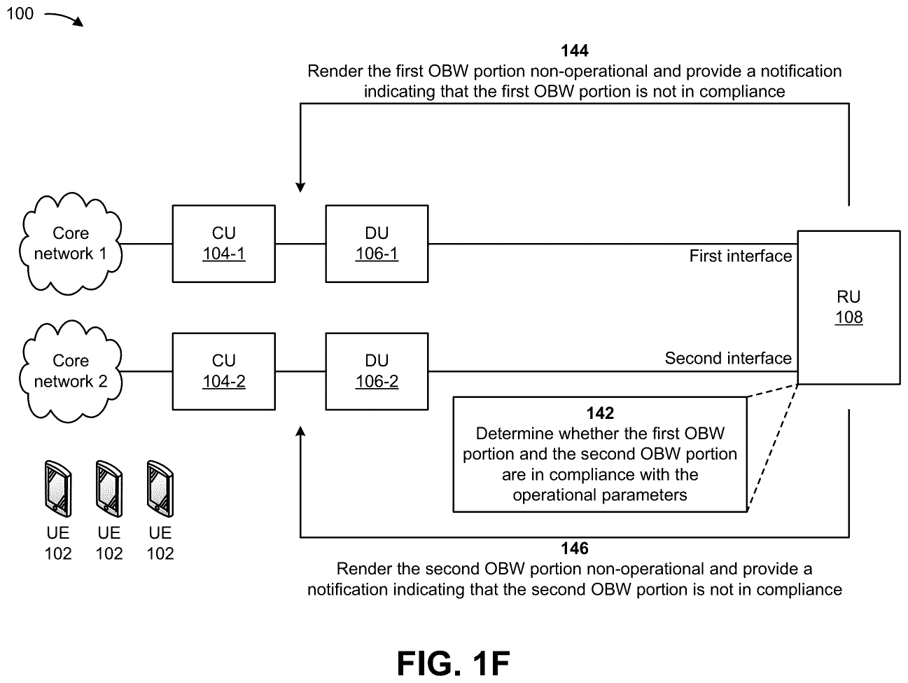

FIGS. 1A-1F are diagrams of an example 100 associated with managing a MORAN with a single RU. As shown in FIGS. 1A-1F, example 100 includes a plurality of user equipment (UEs) 102, a first core network (e.g., core network 1), a second core network (e.g., core network 2), a first central unit (CU) 104-1, a second CU 104-2, a first distributed unit (DU) 106-1, a second DU 106-2, and an RU 108. Further details of the plurality of UEs 102, the core networks, the CUs 104-1 and 104-2 (also referred to herein as CUs 104, or singularly as CU 104), the DUs 106-1 and 106-2 (also referred to herein as DUs 106, or singularly as DU 106), and the RU 108 are provided elsewhere herein. The first core network, the first CU 104-1, and the first DU 106-1 may be associated with a first occupied bandwidth (OBW) portion provided by the RU 108, and the second core network, the second CU 104-2, and the second DU 106-2 may be associated with a second OBW portion provided by the RU 108. In some implementations, the RU 108 may support three or more core networks, CUs 104, DUs 106, and/or the like

As shown in FIG. 1A, and by reference number 110, the RU 108 may receive a first frequency, time, and phase synchronization from a first OBW portion. For example, a first interface (e.g., an eCPRI fronthaul interface) of the RU 108 may communicate with the first DU 106-1 of the first OBW portion. The first DU 106-1 may generate the first frequency, time, and phase synchronization utilized by the first OBW portion. The first DU 106-1 may provide the first frequency, time, and phase synchronization to the first interface of the RU 108, and the RU 108 may receive the frequency, time, and phase synchronization from the first DU 106-1, via the first interface. Different synchronization techniques are available that provide network timing, frequency, and phase. Several methods for synchronizing a clock in a network use time, frequency, and phase. Frequency refers to a quantity of complete oscillations per second of energy in a form of waves, or a rate at which a periodic event occurs. Frequency synchronization is the ability to distribute precise frequency around a network. Phase refers to a fraction of a cycle of a periodic quantity that has been completed at a specific reference time, expressed as an angle. In phase synchronization, multiple clocks of various frequencies are phase synchronized. Time refers to a time of day. Time synchronization refers to a distribution of time across clocks in a network. Time synchronization is one way of achieving phase synchronization.

As further shown in FIG. 1A, and by reference number 112, the RU 108 may utilize the first frequency, time, and phase synchronization when providing services to the first OBW portion. For example, the RU 108 (e.g., via the first interface) may provide services (e.g., Internet connectivity, online application connectivity, and/or the like) to the first OBW portion. The RU 108 may utilize the first frequency, time, and phase synchronization when providing the services to the first OBW portion so that the first OBW portion may receive the services correctly from the RU 108.

As further shown in FIG. 1A, and by reference number 114, the RU 108 may receive a second frequency, time, and phase synchronization from a second OBW portion. For example, a second interface (e.g., an eCPRI fronthaul interface) of the RU 108 may communicate with the second DU 106-1 of the second OBW portion. The second DU 106-1 may generate the second frequency, time, and phase synchronization utilized by the second OBW portion. The second DU 106-1 may provide the second frequency, time, and phase synchronization to the second interface of the RU 108, and the RU 108 may receive the frequency, time, and phase synchronization from the second DU 106-1, via the second interface.

As further shown in FIG. 1A, and by reference number 116, the RU 108 may utilize the second frequency, time, and phase synchronization when providing services to the first OBW portion. For example, the RU 108 (e.g., via the second interface) may provide services (e.g., the same services as provided to the first OBW portion or different services than the services provided to the first OBW portion) to the second OBW portion. The RU 108 may utilize the second frequency, time, and phase synchronization when providing the services to the second OBW portion so that the second OBW portion may receive the services correctly from the RU 108.

As shown in FIG. 1B, and by reference number 118, the RU 108 may select one of the first frequency, time, and phase synchronization or the second frequency, time, and phase synchronization as a primary frequency, time, and phase synchronization. In some implementations, the RU 108 may select one of the first frequency, time, and phase synchronization or the second frequency, time, and phase synchronization as a primary frequency, time, and phase synchronization to utilize when providing services to both the first OBW portion and the second OBW portion. For example, the RU 108 may select the first frequency, time, and phase synchronization as the primary frequency, time, and phase synchronization. Alternatively, for example, the RU 108 may select the second frequency, time, and phase synchronization as the primary frequency, time, and phase synchronization. The logic of selecting which timing to use may be based on multiple factors, such as, for example, a first timing source to be detected upon powering up, always select timing for the first eCPRI port, which timing source is known to be more accurate or more reliable, if one of the DUs 106 only operates as a timing source, and/or the like.

As further shown in FIG. 1B, and by reference number 120, the RU 108 may utilize the primary frequency, time, and phase synchronization when providing services to the first OBW portion. For example, when the RU 108 selects the first frequency, time, and phase synchronization as the primary frequency, time, and phase synchronization, the RU 108 may utilize the first frequency, time, and phase synchronization when providing services to the first OBW portion so that the first OBW portion may receive the services correctly from the RU 108. However, the RU 108 may adjust the second frequency, time, and phase synchronization to match the first frequency, time, and phase synchronization. Alternatively, for example, when the RU 108 selects the second frequency, time, and phase synchronization as the primary frequency, time, and phase synchronization, the RU 108 may utilize the second frequency, time, and phase synchronization when providing services to the first OBW portion so that the first OBW portion may receive the services correctly from the RU 108. However, the RU 108 may adjust the first frequency, time, and phase synchronization to match the second frequency, time, and phase synchronization. A most complex case may occur for TDD time alignment, where TDD slot patterns and timing for both OBWs are to be aligned. The RU 108 may provide sufficient information to the secondary DUs 106 so that the DUs 106 can adjust timing to match the primary. For example, if the primary is operating as a DDSUU but a secondary is operating as a DDDSU, then the secondary may need to switch the TDD mode. Similarly, for phase synchronization, since each DU 106 may have different eCPRT delays to the RU 108, the RU 108 may provide phase adjustments back to the DU 106 for the DU 106 to adjust timing to match the primary. In another example, if the RU 108 has a limit on the OBW (e.g., two hundred MHz) and two different DUs 106 are configured with absolute radio-frequency channel numbers (ARFCNs) that would exceed that OBW, the RU 108 may signal this limitation to the secondary DU 106 and the DU 106 may adjust the ARFCN or bandwidth.

As further shown in FIG. 1B, and by reference number 122, the RU 108 may utilize the primary frequency, time, and phase synchronization when providing services to the second OBW portion. For example, when the RU 108 selects the first frequency, time, and phase synchronization as the primary frequency, time, and phase synchronization, the RU 108 may utilize the first frequency, time, and phase synchronization when providing services to the second OBW portion so that the second OBW portion may receive the services correctly from the RU 108. However, the RU 108 may adjust the second frequency, time, and phase synchronization to match the first frequency, time, and phase synchronization. Alternatively, for example, when the RU 108 selects the second frequency, time, and phase synchronization as the primary frequency, time, and phase synchronization, the RU 108 may utilize the second frequency, time, and phase synchronization when providing services to the second OBW portion so that the second OBW portion may receive the services correctly from the RU 108. However, the RU 108 may adjust the first frequency, time, and phase synchronization to match the second frequency, time, and phase synchronization.

In some implementations, if the RU 108 determines that the primary frequency, time, and phase synchronization is unavailable, the RU 108 may designate an unselected one of the first frequency, time, and phase synchronization or the second frequency, time, and phase synchronization as a new primary frequency, time, and phase synchronization. In such implementations, the RU 108 may utilize the new primary frequency, time, and phase synchronization when providing the services to the first OBW portion, and may utilize the new primary frequency, time, and phase synchronization when providing the services to the second OBW portion.

As shown in FIG. 1C, and by reference number 124, the RU 108 may determine a local frequency, time, and phase synchronization associated with the RU 108. For example, the RU 108 may determine the local frequency, time, and phase synchronization associated with the RU 108, and may synchronize the local frequency, time, and phase synchronization with the first frequency, time, and phase synchronization and the second frequency, time, and phase synchronization. In some implementations, the RU 108 may utilize an external timing source (e.g., a GPS receiver or a PTP source) that connects to the RU 108 or is inserted via a local switch into one of the eCPRI ports of the RU 108.

As further shown in FIG. 1C, and by reference number 126, the RU 108 may utilize the local frequency, time, and phase synchronization when providing services to the first OBW portion. For example, when the RU 108 synchronizes the local frequency, time, and phase synchronization with the first frequency, time, and phase synchronization, the RU 108 may utilize the local frequency, time, and phase synchronization when providing the services to the first OBW portion so that the first OBW portion may receive the services correctly from the RU 108.

As further shown in FIG. 1C, and by reference number 128, the RU 108 may utilize the local frequency, time, and phase synchronization when providing services to the second OBW portion. For example, when the RU 108 synchronizes the local frequency, time, and phase synchronization with the second frequency, time, and phase synchronization, the RU 108 may utilize the local frequency, time, and phase synchronization when providing the services to the second OBW portion so that the second OBW portion may receive the services correctly from the RU 108.

As shown in FIG. 1D, and by reference number 130, the RU 108 may designate the first OBW portion or the second OBW portion as a primary OBW portion and may reject operational parameters conflicting with operational parameters of the primary OBW portion. For example, the RU 108 may align certain operational parameters between the first OBW portion and the second OBW portion. The operational parameters may include an absolute radio-frequency channel number (ARFCN), channel bandwidth, bandwidth parts, a time division duplex (TDD) cycle, and/or the like. In some implementations, the RU 108 may designate the first OBW portion as the primary OBW portion and may reject operational parameters of the second OBW portion that conflict with operational parameters of the first OBW portion (e.g., as the primary OBW portion). Alternatively, the RU 108 may designate the second OBW portion as the primary OBW portion and may reject operational parameters of the first OBW portion that conflict with operational parameters of the second OBW portion (e.g., as the primary OBW portion).

As further shown in FIG. 1D, and by reference number 132, the RU 108 may utilize all non-rejected operational parameters when providing services to the first OBW portion. For example, when the RU 108 designates the first OBW portion as the primary OBW portion, the RU 108 may utilize all of the operational parameters of the first OBW portion when providing services to the first OBW portion. Alternatively, when the RU 108 designates the second OBW portion as the primary OBW portion, the RU 108 may utilize the operational parameters of the first OBW portion, that do not conflict with the operational parameters of the second OBW portion, when providing services to the first OBW portion. The RU 108 may notify the first DU 106-1 of the operational parameters utilized by the RU 108 for the first OBW portion.

As further shown in FIG. 1D, and by reference number 134, the RU 108 may utilize all the non-rejected operational parameters when providing services to the second OBW portion. For example, when the RU 108 designates the first OBW portion as the primary OBW portion, the RU 108 may utilize the operational parameters of the second OBW portion, that do not conflict with the operational parameters of the first OBW portion, when providing services to the second OBW portion. Alternatively, when the RU 108 designates the second OBW portion as the primary OBW portion, the RU 108 may utilize all of the operational parameters of the second OBW portion when providing services to the second OBW portion. The RU 108 may notify the second DU 106-2 of the operational parameters utilized by the RU 108 for the second OBW portion.

As shown in FIG. 1E, and by reference number 136, the RU 108 may select operational parameters based on configuration settings associated with the first OBW portion and the second OBW portion. For example, the RU 108 may apply weights to the configuration settings associated with the first OBW portion and the second OBW portion. The RU 108 may utilize the weights applied to the configuration settings associated with the first OBW portion to select the operational parameters to be utilized by the RU 108. The RU 108 may utilize the weights applied to the configuration settings associated with the second OBW portion to select the operational parameters to be utilized by the RU 108.

As further shown in FIG. 1E, and by reference number 138, the RU 108 may utilize the selected operational parameters when providing services to the first OBW portion. For example, the RU 108 may utilize the operational parameters, selected based on the weights applied to the configuration settings associated with the first OBW portion, when providing services to the first OBW portion.

As further shown in FIG. 1E, and by reference number 140, the RU 108 may utilize the selected operational parameters when providing services to the second OBW portion. For example, the RU 108 may utilize the operational parameters, selected based on the weights applied to the configuration settings associated with the second OBW portion, when providing services to the second OBW portion.

In some implementations, the RU 108 may process the configuration settings associated with the first OBW portion and the second OBW portion, with a machine learning model, to select operational parameters. The RU 108 may utilize the selected operational parameters when providing services to the first OBW portion, and may utilize the selected operational parameters when providing services to the second OBW portion. In some implementations, the machine learning model may include a clustering model. A clustering model may use cluster analysis (also known as clustering) to perform machine learning. Cluster analysis is the task of grouping a set of objects in such a way that objects in the same group (called a cluster) are more similar (in some sense) to each other than to objects in other groups (clusters). Cluster analysis can be achieved by various algorithms that differ significantly in their notion of what constitutes a cluster and how to efficiently find them. Popular notions of clusters include groups with small distances between cluster members, dense areas of the data space, intervals or particular statistical distributions, and/or the like. Different cluster models (with correspondingly different cluster algorithms) may include connectivity models (e.g., where hierarchical clustering builds models based on distance connectivity), centroid models (e.g., where the k-means algorithm represents each cluster by a single mean vector), distribution models (e.g., where clusters are modeled using statistical distributions, such as multivariate normal distributions used by the expectation-maximization algorithm), density models (e.g., where clusters are defined as connected dense regions in the data space), and/or the like.

As shown in FIG. 1F, and by reference number 142, the RU 108 may determine whether the first OBW portion and the second OBW portion are in compliance with the operational parameters. For example, the RU 108 may enforce the operational parameters for the first OBW portion and the second OBW portion. The RU 108 may enforce the operational parameters by determining whether the first OBW portion and the second OBW portion are in compliance with the operational parameters. In some implementations, the RU 108 may determine that the first OBW portion is not in compliance with the operational parameters, that the second OBW portion is not in compliance with the operational parameters, that both the first OBW portion and the second OBW portion are not in compliance with the operational parameters, and/or the like.

As further shown in FIG. 1F, and by reference number 144, the RU 108 may render the first OBW portion non-operational and may provide a notification indicating that the first OBW portion is not in compliance. For example, when the RU 108 determine that the first OBW portion is not in compliance with the operational parameters, the RU 108 may render the first OBW portion non-operational and may generate a notification indicating that the first OBW portion is rendered non-operational since the first OBW portion is not in compliance with the operational parameters. The RU 108 may provide the notification to the first DU 106-1 of the first OBW portion.

As further shown in FIG. 1F, and by reference number 146, the RU 108 may render the second OBW portion non-operational and may provide a notification indicating that the second OBW portion is not in compliance. For example, when the RU 108 determine that the second OBW portion is not in compliance with the operational parameters, the RU 108 may render the second OBW portion non-operational and may generate a notification indicating that the second OBW portion is rendered non-operational since the second OBW portion is not in compliance with the operational parameters. The RU 108 may provide the notification to the second DU 106-2 of the second OBW portion.

In this way, the RU 108 manages a MORAN. For example, the RU 108 may receive frequency, time, and phase synchronizations from a private network and may ensure that a proper frequency, time, and phase synchronization is provided for each of the public and private networks that share the RU 108. The RU 108 may ensure that operational parameters are aligned between the different private networks, and may enforce the operational parameters on all of the private networks. Thus, the RU 108 may conserve computing resources, networking resources, and/or other resources that would otherwise have been consumed in inefficiently providing services to the private networks of the MORAN, failing to provide sufficient interfaces for the quantity of private networks, failing to provide time aligned TDD signals for the private networks, failing to provide the same duty cycles for the private networks, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

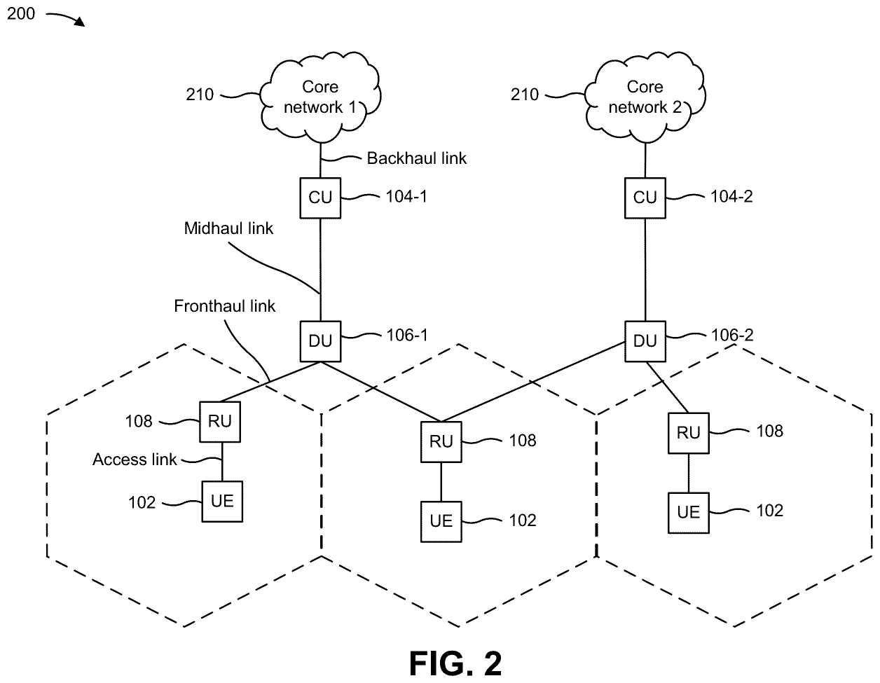

FIG. 2 is a diagram illustrating an example 200 of an O-RAN architecture, in accordance with implementations described herein. As shown in FIG. 2, the O-RAN architecture may include the first CU 104-1 that communicates with a first core network 210 via a backhaul link, and the second CU 104-2 that communicates with a second core network 210 via a backhaul link. Furthermore, each of the CUs 104 may communicate with one or more of the DUs 106 via respective midhaul links. The DUs 106 may each communicate with one or more RUs 108 via respective fronthaul links, and the RUs 108 may each communicate with respective UEs 102 via radio frequency (RF) access links. The DUs 106 and the RUs 108 may also be referred to as O-RAN DUs (O-DUs) 106 and O-RAN RUs (O-RUs) 108, respectively.

In some aspects, the DUs 106 and the RUs 108 may be implemented according to a functional split architecture in which functionality of a base station (e.g., an eNB or a gNB) is provided by the DU 106 and one or more RUs 108 that communicate over a fronthaul link. Accordingly, as described herein, a base station may include the DU 106 and one or more RUs 108 that may be co-located or geographically distributed. In some aspects, the DU 106 and the associated RU(s) 108 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 106 may correspond to a logical unit that includes one or more base station functions to control the operation of one or more RUs 108. For example, in some aspects, the DU 106 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 104. The RU(s) 108 controlled by a DU 106 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 108 handle all over the air (OTA) communication with a UE 102, and real-time and non-real-time aspects of control and user plane communication with the RU(s) 108 are controlled by the corresponding DU 106, which enables the DU(s) 106 and the CU 104 to be implemented in a cloud-based RAN architecture.

In some implementations, the first core network 210, the first CU 104-1, and the first DU 106-1 may be associated with a first OBW portion provided by the RU 108 (e.g., the RU 108 located in the middle of FIG. 2), and the second core network 210, the second CU 104-2, and the second DU 106-2 may be associated with a second OBW portion provided by the RU 108.

As indicated above, FIG. 2 is provided as an example. Other examples may differ from what is described with regard to FIG. 2.

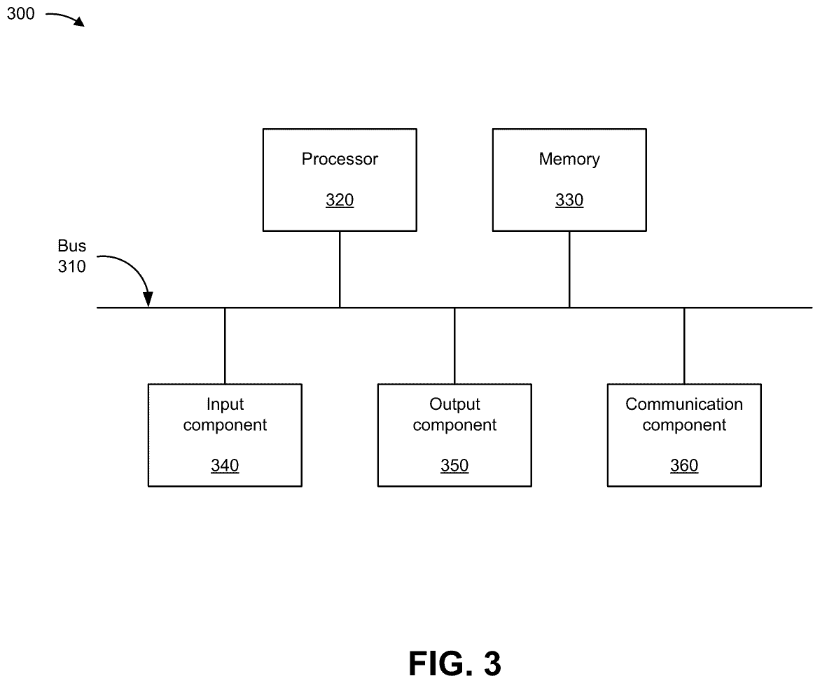

FIG. 3 is a diagram of example components of a device 300, which may correspond to the UE 102, the CU 104, the DU 106, and/or the RU 108. In some implementations, the UE 102, the CU 104, the DU 106, and/or the RU 108 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. Memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

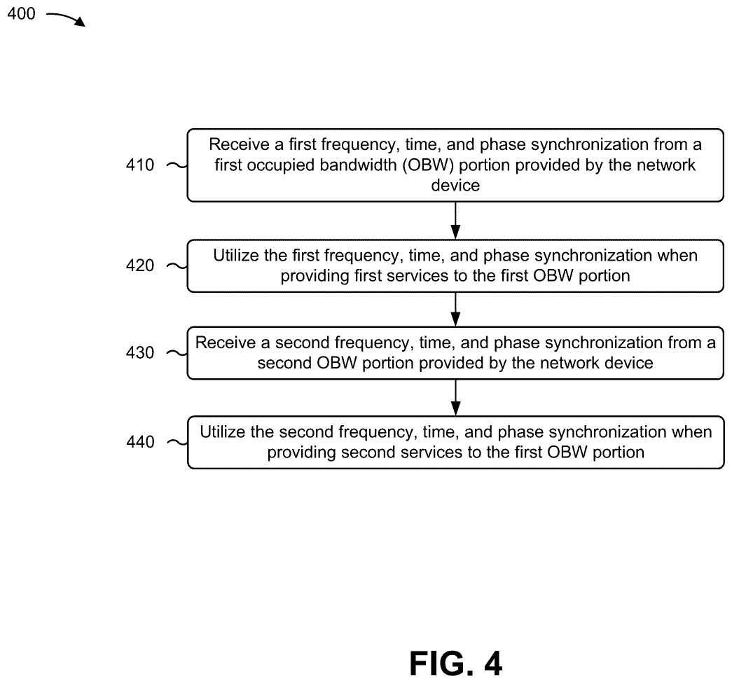

FIG. 4 is a flowchart of an example process 400 for managing a MORAN with a single RU. In some implementations, one or more process blocks of FIG. 4 may be performed by a network device (e.g., the RU 108). In some implementations, one or more process blocks of FIG. 4 may be performed by another device or a group of devices separate from or including the network device, such as a CU (e.g., the CU 104) and/or a DU (e.g., the DU 106). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a first frequency, time, and phase synchronization from a first OBW portion provided by the network device (block 410). For example, the network device may receive a first frequency, time, and phase synchronization from a first OBW portion provided by the network device, as described above. In some implementations, the network device is a radio unit that provides the first OBW portion and the second OBW portion.

As further shown in FIG. 4, process 400 may include utilizing the first frequency, time, and phase synchronization when providing first services to the first OBW portion (block 420). For example, the network device may utilize the first frequency, time, and phase synchronization when providing first services to the first OBW portion, as described above.

As further shown in FIG. 4, process 400 may include receiving a second frequency, time, and phase synchronization from a second OBW portion provided by the network device (block 430). For example, the network device may receive a second frequency, time, and phase synchronization from a second OBW portion provided by the network device, as described above. In some implementations, the first OBW portion is associated with a first core network, a first centralized unit, and a first distributed unit, and the second OBW portion is associated with a second core network, a second centralized unit, and a second distributed unit.

As further shown in FIG. 4, process 400 may include utilizing the second frequency, time, and phase synchronization when providing second services to the first OBW portion (block 440). For example, the network device may utilize the second frequency, time, and phase synchronization when providing second services to the first OBW portion, as described above.

In some implementations, process 400 includes selecting one of the first frequency, time, and phase synchronization or the second frequency, time, and phase synchronization as a primary frequency, time, and phase synchronization; utilizing the primary frequency, time, and phase synchronization when providing additional first services to the first OBW portion; and utilizing the primary frequency, time, and phase synchronization when providing additional second services to the second OBW portion.

In some implementations, process 400 includes determining that the primary frequency, time, and phase synchronization is unavailable; designating an unselected one of the first frequency, time, and phase synchronization or the second frequency, time, and phase synchronization as a new primary frequency, time, and phase synchronization; utilizing the new primary frequency, time, and phase synchronization when providing the additional first services to the first OBW portion; and utilizing the new primary frequency, time, and phase synchronization when providing the additional second services to the second OBW portion.

In some implementations, process 400 includes determining a local frequency, time, and phase synchronization associated with the network device, utilizing the local frequency, time, and phase synchronization when providing additional first services to the first OBW portion, and utilizing the local frequency, time, and phase synchronization when providing additional second services to the second OBW portion.

In some implementations, process 400 includes designating the first OBW portion or the second OBW portion as a primary OBW portion; rejecting operational parameters conflicting with operational parameters of the primary OBW portion; utilizing non-rejected operational parameters when providing the first services to the first OBW portion; and utilizing the non-rejected operational parameters when providing the second services to the second OBW portion.

In some implementations, process 400 includes selecting operational parameters based on configuration settings associated with the first OBW portion and the second OBW portion; utilizing the selected operational parameters when providing the first services to the first OBW portion' and utilizing the selected operational parameters when providing the second services to the second OBW portion.

In some implementations, process 400 includes processing configuration settings associated with the first OBW portion and the second OBW portion, with a machine learning model, to select operational parameters; utilizing the selected operational parameters when providing the first services to the first OBW portion; and utilizing the selected operational parameters when providing the second services to the second OBW portion.

In some implementations, process 400 includes determining whether the first OBW portion and the second OBW portion are in compliance with operational parameters applied to the first OBW portion and the second OBW portion; rendering the first OBW portion non-operational based on determining that the first OBW portion is not in compliance with the operational parameters; and providing a notification indicating that the first OBW portion is not in compliance. In some implementations, the notification includes key performance indicators and status information associated with the first OBW portion.

In some implementations, process 400 includes rendering the second OBW portion non-operational based on determining that the second OBW portion is not in compliance with the operational parameters, and providing another notification indicating that the second OBW portion is not in compliance. In some implementations, the other notification includes key performance indicators and status information associated with the second OBW portion.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, a first frequency, time, and phase synchronization from a first occupied bandwidth (OBW) portion provided by the network device;
utilizing, by the network device, the first frequency, time, and phase synchronization when providing first services to the first OBW portion;
receiving, by the network device, a second frequency, time, and phase synchronization from a second OBW portion provided by the network device; and
utilizing, by the network device, the second frequency, time, and phase synchronization when providing second services to the first OBW portion.

2. The method of claim 1, further comprising:
selecting one of the first frequency, time, and phase synchronization or the second frequency, time, and phase synchronization as a primary frequency, time, and phase synchronization;
utilizing the primary frequency, time, and phase synchronization when providing additional first services to the first OBW portion; and
utilizing the primary frequency, time, and phase synchronization when providing additional second services to the second OBW portion.

3. The method of claim 2, further comprising:
determining that the primary frequency, time, and phase synchronization is unavailable;
designating an unselected one of the first frequency, time, and phase synchronization or the second frequency, time, and phase synchronization as a new primary frequency, time, and phase synchronization;
utilizing the new primary frequency, time, and phase synchronization when providing the additional first services to the first OBW portion; and
utilizing the new primary frequency, time, and phase synchronization when providing the additional second services to the second OBW portion.

4. The method of claim 1, further comprising:
determining a local frequency, time, and phase synchronization associated with the network device;
utilizing the local frequency, time, and phase synchronization when providing additional first services to the first OBW portion; and
utilizing the local frequency, time, and phase synchronization when providing additional second services to the second OBW portion.

5. The method of claim 1, further comprising:
designating the first OBW portion or the second OBW portion as a primary OBW portion;
rejecting operational parameters conflicting with operational parameters of the primary OBW portion;
utilizing non-rejected operational parameters when providing the first services to the first OBW portion; and
utilizing the non-rejected operational parameters when providing the second services to the second OBW portion.

6. The method of claim 1, further comprising:
selecting operational parameters based on configuration settings associated with the first OBW portion and the second OBW portion;
utilizing the selected operational parameters when providing the first services to the first OBW portion; and
utilizing the selected operational parameters when providing the second services to the second OBW portion.

7. The method of claim 1, further comprising:
processing configuration settings associated with the first OBW portion and the second OBW portion, with a machine learning model, to select operational parameters;
utilizing the selected operational parameters when providing the first services to the first OBW portion; and
utilizing the selected operational parameters when providing the second services to the second OBW portion.

8. A network device, comprising:
one or more memories; and
one or more processors, coupled to the one or more memories, configured to:
receive a first frequency, time, and phase synchronization from a first occupied bandwidth (OBW) portion provided by the network device;
receive a second frequency, time, and phase synchronization from a second OBW portion provided by the network device;
select one of the first frequency, time, and phase synchronization or the second frequency, time, and phase synchronization as a primary frequency, time, and phase synchronization;
utilize the primary frequency, time, and phase synchronization when providing first services to the first OBW portion; and
utilize the primary frequency, time, and phase synchronization when providing second services to the second OBW portion.

9. The network device of claim 8, wherein the first OBW portion is associated with one or more first core networks, a first centralized unit, and a first distributed unit, and the second OBW portion is associated with one or more second core networks, a second centralized unit, and a second distributed unit.

10. The network device of claim 8, wherein the network device is a radio unit that provides the first OBW portion and the second OBW portion.

11. The network device of claim 8, wherein the one or more processors are further configured to:
determine whether the first OBW portion and the second OBW portion are in compliance with operational parameters applied to the first OBW portion and the second OBW portion;
render the first OBW portion non-operational based on determining that the first OBW portion is not in compliance with the operational parameters; and
provide a notification indicating that the first OBW portion is not in compliance.

12. The network device of claim 11, wherein the notification includes key performance indicators and status information associated with the first OBW portion.

13. The network device of claim 11, wherein the one or more processors are further configured to:
render the second OBW portion non-operational based on determining that the second OBW portion is not in compliance with the operational parameters; and
provide another notification indicating that the second OBW portion is not in compliance.

14. The network device of claim 13, wherein the other notification includes key performance indicators and status information associated with the second OBW portion.

15. A non-transitory computer-readable medium storing a set of instructions, the set of instructions comprising:
one or more instructions that, when executed by one or more processors of a network device, cause the network device to:
receive a first frequency, time, and phase synchronization from a first occupied bandwidth (OBW) portion provided by the network device;
receive a second frequency, time, and phase synchronization from a second OBW portion provided by the network device;
determine a local frequency, time, and phase synchronization associated with the network device;
utilize the local frequency, time, and phase synchronization, instead of the first frequency, time, and phase synchronization, when providing first services to the first OBW portion; and
utilize the local frequency, time, and phase synchronization, instead of the second frequency, time, and phase synchronization, when providing second services to the second OBW portion.

16. The non-transitory computer-readable medium of claim 15, wherein the one or more instructions further cause the network device to:
select one of the first frequency, time, and phase synchronization or the second frequency, time, and phase synchronization as a primary frequency, time, and phase synchronization;
utilize the primary frequency, time, and phase synchronization when providing additional first services to the first OBW portion; and
utilize the primary frequency, time, and phase synchronization when providing additional second services to the second OBW portion.

17. The non-transitory computer-readable medium of claim 16, wherein the one or more instructions further cause the network device to:
determine that the primary frequency, time, and phase synchronization is unavailable;
designate an unselected one of the first frequency, time, and phase synchronization or the second frequency, time, and phase synchronization as a new primary frequency, time, and phase synchronization;
utilize the new primary frequency, time, and phase synchronization when providing the additional first services to the first OBW portion; and
utilize the new primary frequency, time, and phase synchronization when providing the additional second services to the second OBW portion.

18. The non-transitory computer-readable medium of claim 15, wherein the one or more instructions further cause the network device to:
designate the first OBW portion or the second OBW portion as a primary OBW portion;
reject operational parameters conflicting with operational parameters of the primary OBW portion;
utilize non-rejected operational parameters when providing the first services to the first OBW portion; and
utilize the non-rejected operational parameters when providing the second services to the second OBW portion.

19. The non-transitory computer-readable medium of claim 15, wherein the one or more instructions further cause the network device to:
select operational parameters based on configuration settings associated with the first OBW portion and the second OBW portion;
utilize the selected operational parameters when providing the first services to the first OBW portion; and
utilize the selected operational parameters when providing the second services to the second OBW portion.

20. The non-transitory computer-readable medium of claim 15, wherein the one or more instructions further cause the network device to:
process configuration settings associated with the first OBW portion and the second OBW portion, with a machine learning model, to select operational parameters;
utilize the selected operational parameters when providing the first services to the first OBW portion; and
utilize the selected operational parameters when providing the second services to the second OBW portion.
